(19) United States
(12) Patent Application Publication
(10) Pub. No.: US 2017/0206617 A1
(43) Pub. Date: Jul. 20, 2017

(54) Methods and system for enrollment and recruiting practices using an integrated advancement system

(71) Applicant: Arman Majidi, Fountain Valley, CA (US)

(72) Inventor: Arman Majidi, Fountain Valley, CA (US)

(21) Appl. No.: 14/997,390

(22) Filed: Jan. 15, 2016

(51) Int. Cl. G06Q 50/20

(52) U.S. Cl. CPC G06Q 50/2053

(57) ABSTRACT

A method and system for recruiting using various models to query, analyze, and process information pertaining to potential candidates for selection and acquisition is herein described. In particular, this innovation will revolutionize the current recruitment and application screening process to obtain admission for and gain entrance into an organization. The current bottom-up structure of the education systems requires students to find suitable organizations for pursuit of advancement. This new system (the Integrated Advancement System or IAS) provides a top-down structure to recruitment providing school recruiters the tools and information to pursue potential candidates for admission. For example, utilizing this new system students and schools will login to their respective portals with IAS to upload their information so that students and schools can then access a large pool of potential candidates. Students can then find schools they are interested in attending and identify schools matching their preferences. Schools will then be provided access to an aggregated candidate database (IAS) of potential students to search through and identify candidates for admission to their institution and request applications.

### BACKGROUND OF THE INVENTION

1. Field of the Invention

The present invention relates generally to the field of information distribution and control. More particularly, the present application relates to collecting and storing information from candidates and institutions for later retrieval, analysis, and processing by academic institution representatives through secure private networks for identifying preferred candidates for admission.

2. Description of Related Art

Individuals desiring to attend schools tend to dislike the overall application process. In particular, potential students must initially search for the right institution to apply for to obtain the best education relating to their goals. Most potential students have difficulty identifying their interest in pursuing degrees in specific subject areas. Further, many potential students cannot foresee potential future employment.

On the other hand, most schools are having difficulty identifying a potential pool of students to review for admission. This is not due to a lack of interest on the part of the students. Rather, the issue arises from the current structure of the education system and process of applying for admission at any level.

Furthermore, most schools these days have internal structures which disconnect recruitment of potential students and advertising for the institution. Most advertising relates to creating and maintaining a brand that distinguishes the institution based on its mission and ideology. While recruiters are interested in selling that brand to obtain new enrollees. Sometimes these interests do not overlap.

### SUMMARY OF THE INVENTION

The present invention avoids disadvantages described above as well as other disadvantages. One aspect of the invention involves providing a method and system that facilitates interaction between prospective students seeking education and schools, as well as between schools. Initially, separate databases of prospective students and schools are created. The database of students is available to schools and the database of schools is available to both schools and students via an electronic communications medium such as virtualized environments. Through the schools database only review of information is available. One innovation includes the new structure of recruiting by institutions. In this system, the student's database provides registered school representatives the ability to filter, search, and match students to specified criteria. The educational institutions provide a financial payment for access to the prospective student database (PSDB). The prospective students would be required to pay a registration fee which would allow them access to the schools database and will allow the student to apply to various institutions avoiding a variety of fees. Thus, the method and system allows schools to match their desired characteristics to a database of potential candidates thereby efficiently managing and maximizing yearly enrollment rates.

Various aspects as well as objects, features, and advantages of the present invention are described in the following Detailed Description which is to be read in conjunction with the accompanying drawings.

### BRIEF DESCRIPTION OF THE DRAWINGS

FIG. 1 is a schematic block diagram view of one overall process of the invention;

FIG. 2 is a schematic block diagram portraying a general version of the invention;

FIG. 3 is a schematic portraying one aspect of the invention shown in FIG. 1;

FIG. 4 is a schematic showing another aspect of the invention shown in FIG. 1;

FIG. 5 is a schematic showing one version of the control system shown in FIG. 1;

### DETAILED DESCRIPTION

The present invention relates to a method and system (hereinafter referred to as “IAS”), which facilitates a novel approach to recruitment and admission. The system is inherently a process of creating a pool of candidates for selection by education institutions (hereinafter referred to as “Schools”). Schools include any and all institutions of education including secondary and post-secondary, not limited to, private schools, post-secondary schools, graduate schools, and any program typically at universities and colleges. This also includes other advanced programs, intermediate skills training, continuing education programs, trade schools, and vocational schools. Students include any individual currently attending one of the aforementioned institutions that is the legal age of 18 years old. A prospective student refers to an individual, currently or previously enrolled at any of the aforementioned institutions, and not limited to, individuals currently on a leave of absence, withdrawn, or otherwise removed from any aforementioned institution. Schools and students can register with IAS directly by accessing the online portal. All communications will be conducted solely via virtual environments, unless otherwise instructed or in the event of access failure, interruption of service, and/or outage in which all communications will continue via conventional means of mail transport.

In one embodiment, the present invention functions as a system of evaluation, interest assessment, and commitment indicator for institutions by allowing students and prospective students (hereinafter referred to as “Students”) the ability to access a database of Schools for scoring, contributing, and other actions and efforts, not limited to, showing interest, requesting information, requesting review/apply, access information, apply, respond to inquiries, respond to requests, issue statements, as well as others. According to security protocol for implementation, the individual identity of a Student would not be made available to the School until the School has requested an application and the Student has accepted to start the application process for the interested School.

In one implementation, Schools would pay for access to the database of all Students to identify preferred candidates for admission. As an incentive IAS will provide a substitute to many of the costs of admission and other related expenses Schools may incur. Students would pay for access to the IAS database of Schools which will then include the cost of applying to any institution. For the payment from Students, IAS will provide up to 10 full application submissions to various Schools, including subsequent applications to the same School. As an incentive, Students will only have to find their documentation once and provide it to only one institution, rather than creating several copies of packets for distribution to multiple institutions. Further incentives include the ability to focus on studying and preparing for success at any Schools while said institutions will find and identify probable candidates for admission.

Documentation herein refers to any and all information, official or otherwise, not limited to, personal, physical, emotional, intellectual, or otherwise, related to any individual Student.

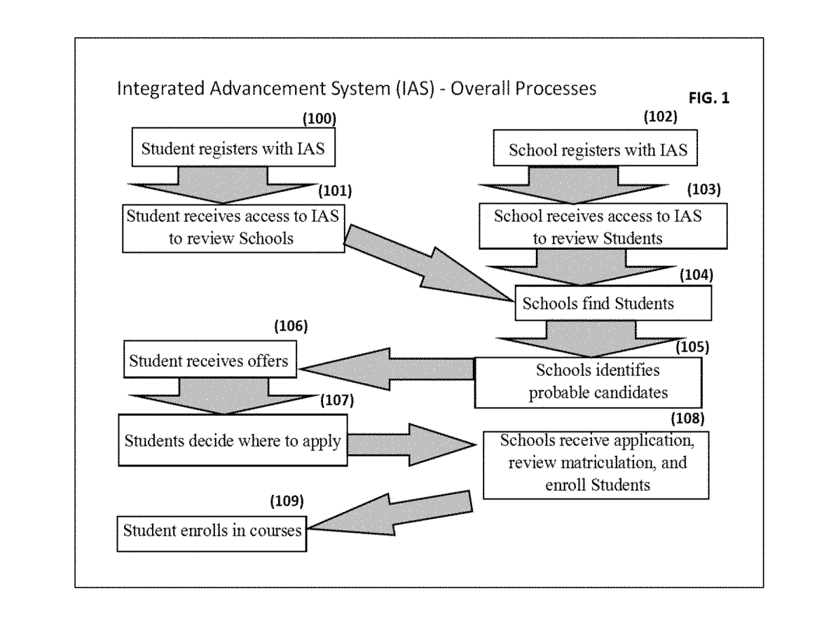

Referring to the drawings, shown in FIG. 1 is a schematic block view of one overall process of the invention from start to end. Beginning with block 100 Students register with IAS having established eligibility and paid the fee. Students then are given access to the portal and Schools database, shown in block 101. Block 102 illustrates Schools registering with IAS, then block 103 shows Schools receiving access to their school portal and accessing the Students database. Block 104 illustrates Schools searching and matching Students to their criteria. Block 105 shows schools identifying candidates and offering potential admission to their institution. Block 106 represents the Students ability to filter offers from Schools and apply only to those institutions where they will likely receive admission, shown in block 107. Block 108 illustrates the Schools receiving the student information, reviewing matriculation, and enrolling students. Block 109 shows Students enrolling in the institution.

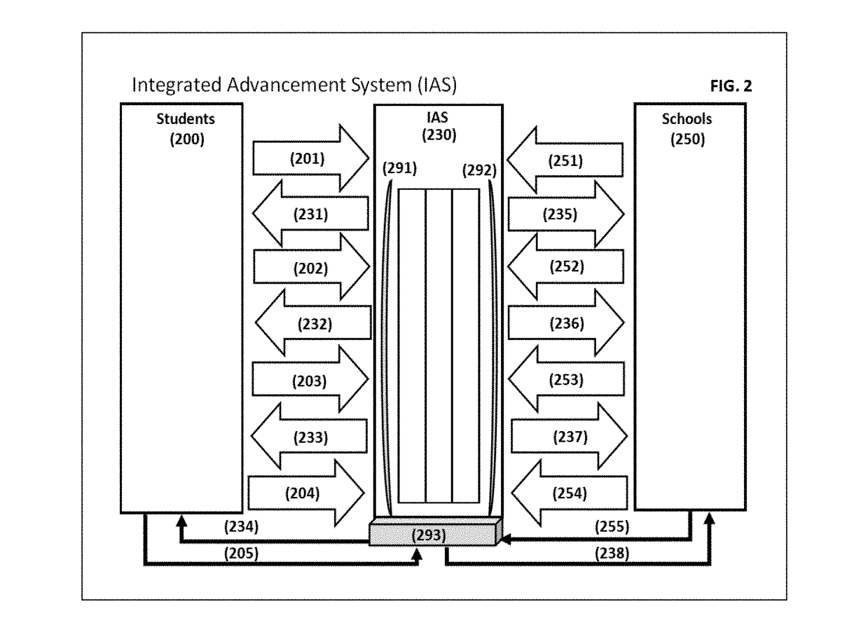

FIG. 2 is a schematic block diagram portraying a general version of the invention. Block 200 illustrates the Students, block 230 shows IAS, and block 250 represents the Schools. Block 201 shows the student registering with IAS. Block 231 shows IAS granting access to the database. Block 202 shows Students showing interest and taking other actions. Block 251 shows Schools registering with IAS. Block 235 shows IAS granting access to the database. Block 252 illustrates Schools making requests, asking for certain applicants, and taking other actions. Block 232 shows IAS communicating those Schools' requests to individuals in the Students database. Block 203 represent the Students decisions to apply to particular institutions which have shown interest. Block 236 illustrates IAS transmitting information about potential applicants to Schools. Block 253 shows Schools asking for applications from potential applicants provided by IAS. Block 233 represents IAS communicating the application requests to an individual in the Students database which have been selected to apply. Block 204 shows the Students indicating their intent to apply. Block 237 illustrates IAS transmitting the intent to apply back to Schools. Block 254 illustrates the Schools requesting individual student information. Block 255 shows Schools transmitting the application materials. Block 234 shows IAS transmitting that material to the selected individual in the Students database. Block 205 shows the application being completed and sent back to the IAS for transmission to the specified institutions in the Schools database. Block 238 show the receipt of the student information and application by the specified institution in the Schools database. Block 291, block 292, and block 293 are security filters and access controllers.

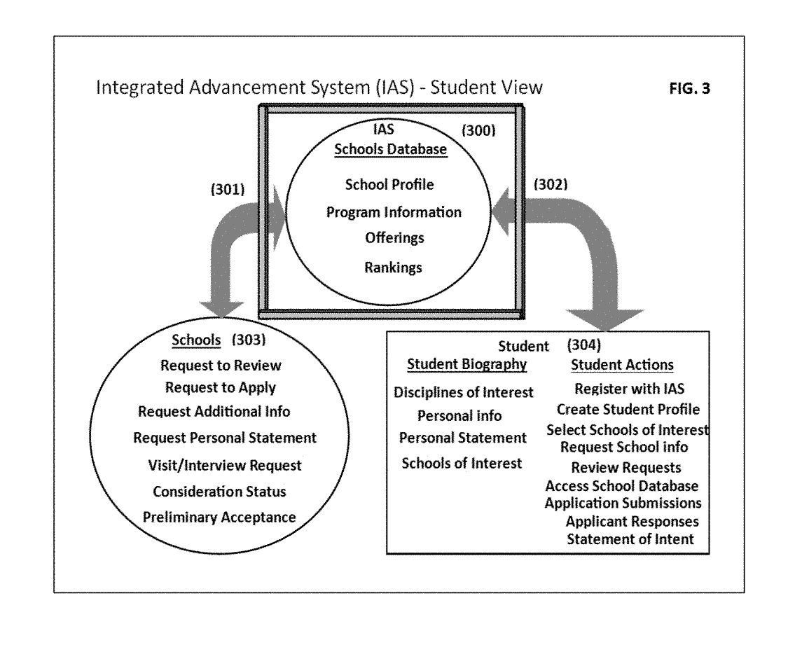

FIG. 3 is a schematic portraying one aspect of the invention shown in FIG. 1 which identifies the Students view of the processes happening in the IAS. Block 300 shows the Schools database within IAS. Block 301 and block 302 are security measures and access controls. Block 303 is the pool of Schools. Block 304 is the pool of Students.

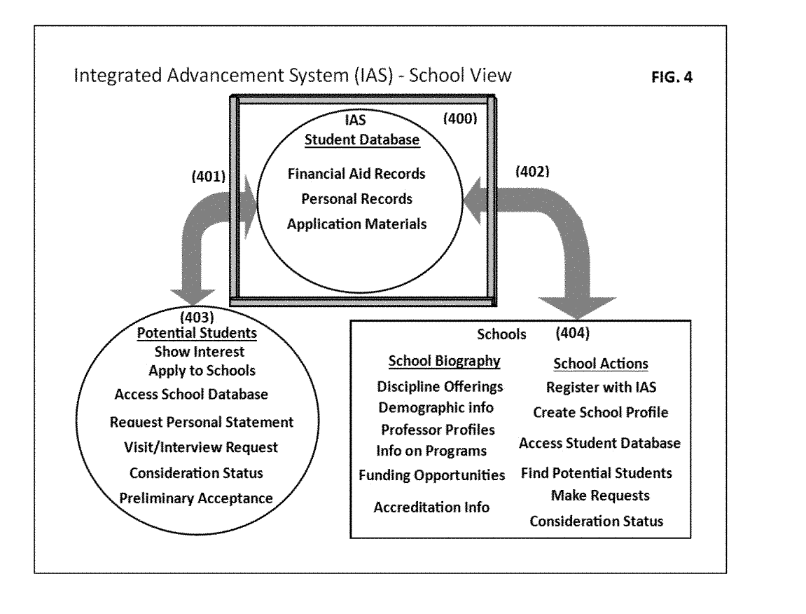

FIG. 4 is a schematic showing another aspect of the invention shown in FIG. 1 which identifies the Schools view of the processes happening in the IAS. Block 400 shows the Students database within IAS. Block 401 and block 402 are security measures and access controls. Block 403 is the pool of Students. Block 404 is the pool of Schools.

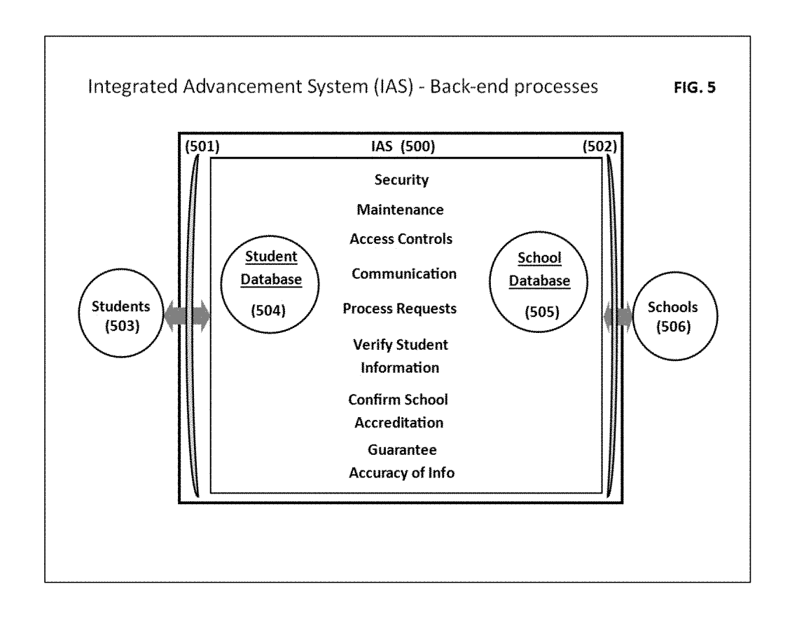

FIG. 5 is a schematic showing one version of the control system shown in FIG. 1 which identifies the IAS apparatus and some of its many functions. Block 500 is the IAS apparatus for allowing Schools the tools to identify their preferred candidates. Block 501 and block 502 are security measures and access controls. Block 503 is the real pool of all students. Block 504 is the pool of Students. Block 505 is the pool of Schools. Block 506 is the pool of all schools.

In the preceding description, we refer to some “embodiments.” Note that some “embodiment” describes a subset of all of the possible embodiments, but does not always specify the same subset of embodiments.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

1. A system for recruiting potential candidates through the use of an aggregated database which includes any and all information pertaining to potential candidates comprising of:
an information and communication technology environment consisting of physical servers, virtualized servers, virtualized desktops for remote access, and various applications to:
receive applications and information from students;
provide accepted applicants with access to a secure database of schools containing any and all information relating to that institution through a student portal;
create a secure database of potential candidates for admission to education institutions;
receive registrations from and information on schools;
provide institutions access to a secure and structured database of potential students containing any and all information relating to students and student performance through a school portal;

2. A method and system of claim (1), further allowing Schools or their representatives access a database of Students for selection.

3. A method of claim (1), wherein said Students include at least one individual student, employer, employer sponsored educational program, employer associations or other special interest group.

4. A method of claim (1), wherein said Schools includes at least one private school, post-secondary school, under graduate school, graduate school, post graduate school, doctorate programs, executive management programs, continuing education programs, or trade/vocational school.

5. The method of claim (5), further comprising generating a database containing at least one School.

6. The method of claim (1), further comprising, transmitting, and/or displaying a list of said Students to said Schools.

7. A method of:
a. receiving registration information from at least one Student;
b. receiving registration information from at least one School;
c. matching said Students with said Schools based upon determination of said Schools;
d. transmitting a list to said School, said list containing said Students which match;
e. notifying said Students concerning the status of inclusion on said list;
f. generating a database containing said information from said Students and said Schools;

8. The method of claim (7), wherein said Students registration further comprises receiving a payment from said Students.

9. The method of claim (7), further comprising of transmitting advertising material to said Students and said Schools, said advertising material related to ancillary product or service providers.

10. A method and system for allowing Schools to find potential candidates comprising of:
a. a memory device; and
b. a processor in communication with said memory device and configured to generate a database containing a plurality of Students in communication with a control interface (IAS); receive data at said interface on at least one School; and match said Students with said Schools based upon determination of said Schools.

11. The system of claim (10), further comprising a link connecting the processor to a Schools computer for display of a list of said Students.

12. The system of claim (10), further comprising a link connecting the processor to a Students computer for display of a list of said Schools.

13. The system of claim (10), further including means for transmitting registration information in response to a login request.
